(19) United States
(12) Patent Application Publication
(10) Pub. No.: US 2017/0253514 A1
(43) Pub. Date: Sep. 7, 2017

(54) SYSTEM AND METHOD FOR TREATING OIL / GAS PRODUCTION PROCESS WATERS

(71) Applicants: Steven W. Hanson, Los Alamos, NM (US); Kevin K. Divine, Albuquerque, NM (US)

(72) Inventors: Steven W. Hanson, Los Alamos, NM (US); Kevin K. Divine, Albuquerque, NM (US)

(21) Appl. No.: 15/060,376

(22) Filed: Mar. 3, 2016

(51) Int. Cl. C02F 9/00; C02F 1/56; C02F 1/66; B01D 61/02; B01D 21/01; B01D 21/30; B01D 61/14; C02F 1/52; C02F 1/44

(52) U.S. Cl. CPC C02F 9/00; C02F 1/5209; C02F 1/5281; C02F 1/56; C02F 1/66; C02F 1/444; C02F 1/442; B01D 21/01; B01D 21/305; B01D 61/145; B01D 61/147; B01D 61/027; C02F 2103/10

(57) ABSTRACT

A method and apparatus for treating a water including suspended solids and organics, the method including the method including providing a process stream including suspended solids and organics; adding a predetermined amount of at least one coagulant including at least one of a cationic polymer and nonionic polymer to the process stream to cause coagulation of contaminants including suspended solids and organics; passing the process stream with the coagulant downstream to at least one submicron filtration unit including at least one filter configured to filter particle sizes of about 1 micron or less; filtering the process stream with the at least one submicron filtration unit; and, separating a filtered and unfiltered portion of the process stream from the at least one submicron filtration unit to pass downstream respectively in a filtered and an unfiltered process stream.

### FIELD

Illustrative embodiments of the disclosure generally relate to the treatment of wastewaters generated from oil and gas processes including oil and gas production wells. More particularly, illustrative embodiments of the disclosure relate to a method and apparatus for treating oil and/or gas process waters with a submicron filtration process and apparatus to achieve treated wastewater that may be directly re-used in the same or another oil and/or gas process.

### BACKGROUND

Numerous types of process and wastewaters originating from oil and gas production wells, such as flowback or produced water, have relatively high concentrations of organics, suspended solids and dissolved solids. If such wastewater is to be reused in well field production, for example, in what is commonly referred to as fracking, the wastewater needs to have the contaminants removed to as low a level as practicable in order to reuse as a substitute for fresh water sources.

Submicron filtration processes have typically been used as a pretreatment step for desalting highly saline process and wastewaters. Current practices involve enhancing the operation of nanofiltration (NF) or reverse osmosis (RO) systems usually by manipulating a pH condition, generally in the pH range of approximately 6-11, and filtering before treating with NF or RO.

In the case of such process wastewaters produced by oil and gas operations, the recovery and treatment of such process wastewaters across such filtration systems is often limited by scaling or fouling of the treatment system due to high concentrations of salts, silica, suspended solids or organics. That is, high concentrations of these contaminants in the feed of the process water tend to scale or foul NF or RO systems due to the contaminant concentrations that exceed the practical operational limit of the NF or RO system. Alternatively, the process wastewater treatment system may require an extensive amount of pretreatment of the process wastewater in order to reduce the scaling and fouling tendency. The operation and maintenance of wastewater treatment systems of the prior art is expensive and the down time is costly, resulting in inefficiency.

Therefore, there has been and continues to be a need for an economical method and apparatus for treating oil and gas process wastewaters that avoids or reduces fouling due to organics, avoids or reduces pluggage due to suspended solids, and which efficiently reduces the concentrations of organics and dissolved solids in the process wastewaters.

### SUMMARY

An embodiment of the invention includes a filtration system for treating a water comprising suspended solids and organics, the system including an input line carrying a process stream comprising suspended solids and organics; at least one coagulant addition unit configured to add a predetermined amount of a first coagulant including at least one of cationic polymers and nonionic polymers to the process stream; at least one submicron filtration unit including one or more submicron filters disposed downstream of the coagulant addition unit configured to receive the process stream; a first process stream output line configured to receive an unfiltered portion of the process stream from the at least one submicron filtration unit; and, a second process stream output line configured to receive a filtered portion of the process stream from the at least one submicron filtration unit

Another embodiment of the system includes a method for treating a water comprising suspended solids and organics, the method including providing a process stream including suspended solids and organics; adding a predetermined amount of at least one coagulant including at least one of a cationic polymer and nonionic polymer to the process stream to cause coagulation of contaminants including suspended solids and organics; passing the process stream with the coagulant downstream to at least one submicron filtration unit including at least one filter configured to filter particle sizes of about 1 micron or less; filtering the process stream with the at least one submicron filtration unit; and, separating a filtered and unfiltered portion of the process stream from the at least one submicron filtration unit to pass downstream respectively in a filtered and an unfiltered process stream.

Other objectives and advantages of the present invention will become apparent and obvious from a study of the following description and the accompanying drawings, which are merely illustrative of the invention.

### BRIEF DESCRIPTION OF THE DRAWINGS

Illustrative embodiments of the disclosure will now be described, by way of example, with reference to the accompanying drawings, in which:

FIG. 1 is a schematic illustration of an embodiment of a wastewater treatment system;

FIG. 2 is a schematic illustration of the wastewater treatment system shown in FIG. 1, illustrating another embodiment of the wastewater treatment system.

FIG. 3 is a flow diagram of an illustrative embodiment of a wastewater treatment process using a wastewater treatment system.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable users skilled in the art to practice the disclosure and are not intended to limit the scope of the claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description.

The several embodiments of the present invention may include a wastewater treatment process that includes optional coagulant addition, a submicron filtration unit (any filtration device capable of filtering at about 1.0 micron or less), and an organic trap for treating a secondary waste stream (produced by the submicron filtering process) that includes concentrated amounts of organics, dissolved solids and suspended solids, and where the filtered primary wastestream product is produced preferably at or near natural pH conditions (e.g., pH conditions of from about 5.5 pH to about 10.0 pH).

Various types and forms of oil and gas production process waters (wastewaters) may include several types of contaminants, such as relatively high concentrations of salts, silica, and suspended solids or organics, such as is typically found in oil and gas recovery operations.

In embodiments of the invention, treatment of such wastewaters to meet wastewater reuse needs include the use of submicron filtration for subsequent direct reuse in oil and gas production processes. More specifically, a primary treatment of such wastewaters includes one or more of microfiltration (MF), ultrafiltration (UF) and nanofiltration (NF) including particle removal sizes from about 1.0 micron down to approximately 0.005 microns and a corresponding nominal molecular weight (NMW) cutoff range of 1,000,000 NMW down to 500 NMW.

As used herein, the term “wastewater” refers to an aqueous stream that includes contaminants to be removed by a filtering treatment, and may include one or more of process waters in the oil and gas well production industry referred to as process water, flowback water, produced water, and surface or groundwater that is currently being used for a process or has been added or blended for the process, such as fracking or other oil and gas processes.

Submicron filtration systems utilizing MF, UF or NF has been unexpectedly found to be an effective means of achieving a treated wastewater suitable for direct or near direct reuse. For example, wastewater treated by submicron may be directly reused without the necessity of further treatment. The treated wastewater results in a reusable fracking fluid that is inherently compatible, including pH characteristics, with the same or another oil and gas production process. The term “direct reuse” means that no further wastewater treatment is necessary prior to reuse of the treated wastewater in the same or another oil and gas production process.

Embodiments include a system for recovery of a highly concentrated, oily, secondary waste stream (separated from the treated wastewater for direct reuse) including a coagulant addition unit and an organic adsorber unit including an absorber or sponge. In other embodiments one or more of the coagulant addition and organic adsorber/absorber units may be associated with injection lines to inject one or more coagulants. In additional embodiments, one or more filtration units including submicron filtration units may be provided downstream from the one or more adsorber/absorber units to further treat the secondary wastewater stream, thus further reducing the requirement for extensive waste handling.

Embodiments of the present invention further include a method or process for treating wastewaters associated with the production of oil and gas, utilizing a submicron filtration unit for the removal of suspended solids and organics. In other embodiments the pH of the wastewater is maintained during the treatment or following treatment at a level in a range at or near its naturally occurring level prior to use in a gas and oil production process, for example, from about pH 5.5 to about pH 10, more preferably from about 5.5 to about 8.5. By the term “naturally occurring” is meant the pH level of water obtained for use in an oil and gas process prior to the addition of process additives.

In some embodiments, the pH of the treated wastewater may be optionally adjusted during treatment to enhance the effectiveness of a submicron filtration process including the effectiveness of one or more an additive coagulants. In some embodiments, the additive coagulants may include one or more organic and/or inorganic coagulants including one or more cationic and/or non-ionic polymers. For example, the one or more additive coagulants may cause suspended solids and organic compounds to be coagulated in the feed stream, preferably without significantly changing the pH of the wastewater.

In additional embodiments, the pH may be adjusted during the treatment process to include a range of about pH 4 to about pH 10. In yet other embodiments, the pH of the wastewater during treatment may be monitored and adjusted in response to the monitoring during treatment to achieve a desired filtration performance of the submicron filtration unit, for example to achieve a desired concentration of contaminants remaining in the wastewater following submicron filtration treatment. In some embodiments the pH may be adjusted with an additive following submicron filtration.

In some embodiments, wastewater process stream is directed through a submicron filtration process to reduce a level suspended solids and/or organics and produce a primary filtered wastewater stream (product stream) and a secondary unfiltered wastewater stream that may further concentrate filtered suspended solids and/or organics.

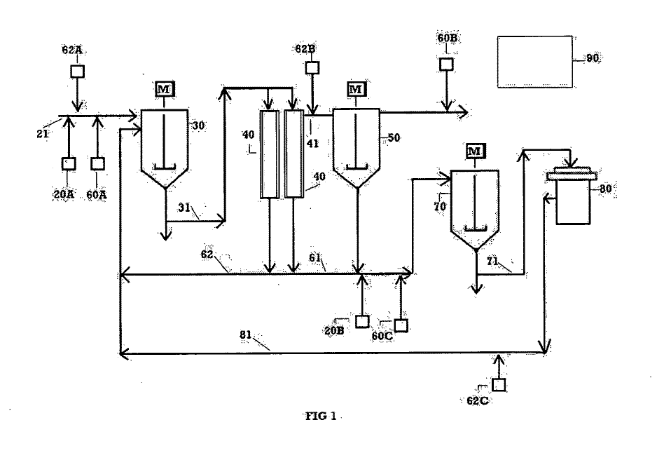

Turning to FIG. 1, an illustrative embodiment of a wastewater treatment system is shown and the system indicated generally by the numeral 10. The system 10 includes a feed coagulant addition unit 20A; a feed tank 30 which may include a mixer, M; at least one filtration unit 40 (may be multiple pass and may include one or more of MF, UF and NF filtration subunits); a secondary coagulant addition unit 20B; an organic capture unit 80 (unfiltered process stream); a product tank 50 (filtered process stream for reuse); which may include a mixer, M; and an oily waste recovery tank 70. By the term “multiple pass” is meant that the feed waste stream may be filtered by a filtration unit including a plurality of submicron filtration subunits disposed adjacent one another in a compact arrangement (skid) and that may include one or more of MF, UF and NF submicron filters.

As shown in FIG. 1, in one embodiment, one or more coagulant addition units e.g., 20A, 20B may be included in the treatment process e.g., within the wastewater treatment system to treat the wastewater process stream by injecting one or more additive coagulants in-line in the wastewater treatment stream.

In one embodiment, one or more coagulant addition units e.g., 20A may be placed upstream of the one or more filtering units 40 e.g., in line 21. In another embodiment, one or more coagulant addition units e.g., 20B may be placed downstream of the filtering units 40 e.g., in line 61 of the unfiltered wastewater treatment stream and upstream, within and/or downstream of oily waste recovery tank 70. The coagulant addition units e.g., 20A and 20B may include any in-line additive apparatus known in the art such as including one or more of a blend tank, an injection pump and a tank mixer e.g., to optionally mix the additive within the blend tank prior to injection into the wastewater treatment stream.

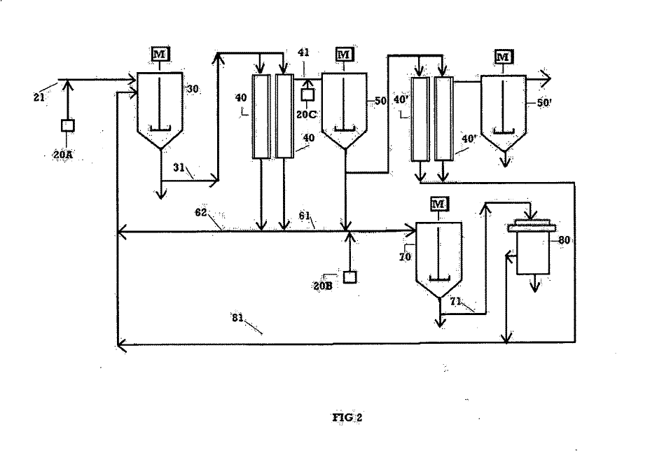

Referring to FIG. 2, in another embodiment, the wastewater treatment system 10 may be provided with at least two submicron filtration units 40 and 40′ where each submicron filtration unit may include one or more subunits and/or filters. It will be appreciated that FIG. 2 may include the same or similar features as described for FIG. 1, and may further include a second product tank 50′ that may be connected to recycle line 81 and/or organic capture unit 80 as further explained below.

For example, due to the nature and characteristics of the feed water, it may be desirable to utilize multiple submicron filtration units and/or subunits in order to efficiently remove both suspended solids and organics, or where additional concentration of the contaminants may be desirable. In one embodiment, where multiple filtration units are employed, e.g., such as units 40 and 40′, coagulant addition may be provided between the two filtration units. In one embodiment, a coagulant addition unit, e.g., 20C may be provided for injecting the same and/or another coagulant such as a non-ionic and/or cationic polymer, into the filtered waste water treatment stream.

In some embodiments, one or more coagulant addition units e.g., 20C may be placed upstream of the one or more filtration units 40′ e.g., in line 41 between the filtering units 40 and 40′, e.g., upstream, downstream and/or within mixing tank (M) 50. Coagulant addition unit e.g., 20C may be in addition to coagulant addition units 20A and/or 20B shown in FIG. 1. Coagulant addition unit e.g., 20C may inject the same and/or another coagulant as coagulant addition units 20A and/or 20B, such as a non-ionic and/or cationic polymer, into the filtered waste water treatment stream.

In further embodiments, the coagulant addition units may be in wired and/or wireless communication with one or more controllers, e.g., 90.

In some embodiments one or more filtration units 40 may include one or more submicron filters including e.g., a microfiltration (MF) filter (particle size filtering of from about 0.05 micron to about 5 microns and corresponding to a nominal molecular weight (NMW) range of about 100,000 to about 1,000,000) and/or ultrafiltration (UF) filter (particle size filtering of about 0.005 microns to about 0.5 microns and corresponding to a nominal molecular weight (NMW) range of about 1,000 to about 300,000). The one or more submicron filtration units 40 may be utilized to remove suspended solids and/or coagulated organics in the wastewater treatment stream passing through the unit to produce a filtered reuse stream e.g., in line 41 and an unfiltered wastestream e.g., in line 61. A nanofiltration (NF) filter (particle size filtering of about 0.002 microns to about 0.005 microns and corresponding to a nominal molecular weight (NMW) range of about 250 to about 5,000) may be used if necessary to achieve a desired dissolved solid contaminant level in the filtered reuse stream.

In various embodiments the filtration units 40 may include one or more submicron filters having one or more configuration types known in the art including filter membrane configurations such as flat sheet, spiral wound, hollow fine fiber, and tubular. Other features as are known in the art may include centrifugal force (spinning disk), vibration of the membrane to avoid fouling or plugging, acoustic vibration, and submersion. In further embodiments, filter membrane materials may include one or more of natural organic (cellulosic), composite, polymeric, metal and ceramic.

In some embodiments, one or more of the submicron filtration units 40 may include one or more filters provided on respective separate skids (filtration subunit holders), and/or may include a plurality of filters on a single skid.

In other embodiments, one or more pH measuring and/or pH adjustment units e.g., 60A, 60B, and 60C may be included in the treatment process e.g., within the wastewater treatment system 10 to treat the wastewater treatment stream. For example, one or more pH measuring and/or pH adjustment units e.g., 60A may be placed in-line, e.g. line 21, upstream and/or downstream of a coagulant addition unit e.g., 20A and upstream of the one or more filtering units e.g., 40.

In related embodiments, one or more pH measuring and/or pH adjustment units e.g., 60B may be placed in-line downstream of the one or more filtering units 40, e.g., in line 41, within, upstream or downstream of the product tank 50 to measure and/or adjust the pH of the filtered wastewater treatment stream in line 41. Further, in additional embodiments, one or more pH measuring and/or pH adjustment units e.g., 60C may be placed in-line downstream of the one or more filtering units e.g., 40, e.g., within, upstream or downstream of the organic capture unit 80 to measure and/or inject pH adjusting additives into the unfiltered wastewater treatment stream in line 61.

The one or more pH measuring and/or pH adjustment units may include pH measurement devices and/or pH additive devices that are known in the art. The pH measuring unit may be integral with or separate from a pH additive unit and the pH measuring unit may include pH measurement sensors as are known in the art upstream and/or downstream of the in-line pH additive point. The pH additive unit include a conventional injector as known in the art including one or more of a blend tank, an injection pump and a tank mixer e.g., to mix the additive within the blend tank prior to injection. The pH additive unit may include or be connected to a source of one or more chemicals that are typically added to adjust the pH of liquid solutions including e.g., hydrochloric acid (HCl) and/or sodium hydroxide (NaOH).

In another embodiment, the one or more pH measuring and/or pH adjustment units may be in communication, including wired and/or wireless communication, with one or more controllers, e.g., 90, which may include one or more processors and memory as are known in the art where the controller is configured to execute programmed instructions stored in memory.

In yet other embodiments, one or more contaminant indicator units, e.g., 62A, 62B, 62C may be included in the treatment process e.g., included in the wastewater treatment system 10 to measure a condition of the wastewater treatment stream. Preferably, the one or more contaminant indicator units measure and/or sense a condition of the wastewater treatment stream that is proportional to, or indicative of, the level of contaminants present in the wastewater treatment stream.

In one embodiment, the one or more contaminant indicator units preferably at least 62A and 62B may measure the turbidity of the wastewater treatment stream. For example, a suitable turbidity measuring unit may include an instrument capable of measuring scattered light or other electromagnetic radiation, for example a turbidimeter such as those discussed in U.S. Pat. No. 8,760,650, the disclosure of which is incorporated herein by reference.

In other embodiments, the one or more contaminant indicator units, e.g., 62A, may be disposed to make in-line sample measurements of the process stream, e.g., in line 21, upstream and/or downstream of a coagulant addition unit e.g., 20A and upstream of the one or more filtering units 40, to determine an absolute or relative level of contaminants in the feedstream of the wastewater treatment stream in line 21 prior to and/or following coagulant addition.

In another embodiment, the one or more contaminant indicator units, e.g., 62B may be disposed to make in-line sample measurements downstream of the one or more filtering units 40, e.g., in line 41, to determine an absolute or relative level (e.g., relative to contaminant measuring unit 62A) of contaminants remaining in the filtered wastewater treatment stream in line 41 e.g., within, upstream and/or downstream, preferably upstream, of the product tank 50.

In yet another embodiment, one or more contaminant indicator units e.g., 62C may be disposed to make in-line sample measurements e.g., in line 61 downstream of the one or more filtering units 40, to determine an absolute or relative level (e.g., relative to contaminant indicator units 62A and/or 62B) of contaminants in the unfiltered wastewater treatment stream in line 61, e.g. within, upstream and/or downstream, of the organic capture unit 80. It will be appreciated that in some cases, the unfiltered wastestream may become too concentrated to measure the turbidity.

In some embodiments, the one or more contaminant indicator units, 62A, 62B, 62C may be in communication, including wired and or wireless communication, with the one or more controllers, e.g., 90.

In other embodiments, a secondary waste stream e.g., in line 61 will be produced by passing the primary wastestream (in line 21) through the one or more filtration units 40 which may then be directed to an oily waste recovery tank 70 and to be subsequently treated with the organic capture unit 80.

In related embodiments, the oil waste recovery tank and organic capture unit may include apparatus that are known in the art, for example the oil waste recovery tank 70 may include various level ports to allow the separation of oil from water for specific stream withdrawal and treatment, and the organic capture unit 80 may include one or more types of chemically selective polymers known in the art capable of hydrocarbon adsorption.

In exemplary operation, one or more coagulant additives, typically one or more cationic and/or non-ionic polymers, may be injected by coagulant additive unit e.g., 20A into line 21 and pre-mixed or mixed in-line with the feedwater of the wastewater treatment stream (primary wastestream). A typical dosage for the coagulant will depend on the level and type of contaminants present, but typically may range from about 0.1 to about 100 mg/l (milligrams/liter) more preferably from about 1 to about 100 mg/l, even more preferably from about 2 to about 5 mg/l. After the coagulant has been mixed with the feed water, the feed water may be directed downstream to the one or more filtration units 40, through line 31.

In further exemplary operation, extending from the one or more filtration units 40 to the product tank 50 is a connecting line 41. Filtered effluent from the wastewater treatment stream leaving the one or more filtration units 40 may be directed through line 41 to the product tank 50, where it can be withdrawn and repressurized for reuse e.g., in an oil and gas process including a fracking well injection system.

In yet further exemplary operation, connected between the filtration units 40 and the oily waste recovery tank 70 is connecting line 61. In line 61 the same or another coagulant as injected upstream of the filtration units 40 by e.g., coagulant addition unit 20A, may be injected by coagulant additive unit e.g., 20B where the coagulant may be pre-mixed, or mixed in-line with the unfiltered wastewater treatment stream. A typical dosage for the coagulant will depend on the level and type of contaminants present, but typically may range from about 0.1 to about 100 mg/l (milligrams/litter) more preferably from about 1 to about 100 mg/l, even more preferably from about 2 to about 5 mg/l. After the coagulant has been injected into the unfiltered wastewater treatment stream, the unfiltered wastewater treatment stream may be directed downstream to the oily waste recovery tank 70.

In another embodiment of further exemplary operation, the process stream from the oily waste recovery tank 70 may be directed downstream through line 71 to the organic capture unit 80. Treated effluent from the organic capture unit 80 may then be directed through line 81 to the feed tank 30 for recyling.

In other embodiments, the unfiltered wastewater stream may be further treated to further concentrate the oily residue in the unfiltered wastewater stream. In one embodiment, the unfiltered wastewater stream from the filtration unit 40 may be directed back to the feed tank 30 for recycling and further filtering e.g., through line 62 that connects with line 81 carrying the treated effluent from the organic capture unit 80.

Shown in Table 1 is a summary of data collected from exemplary treatment processes. The turbidity (expressed as TU) of an exemplary treated feedwater, having typical types of contaminants (e.g., suspended solids and oil) present in a typical oil and gas wastewater stream, was reduced in an initial submicron filtration process from about 182 TU to less than about 3 TU. In preferred embodiments, a majority e.g., greater than about 50%, more preferably greater than about 80% of the suspended solids and organics (e.g. oil) present in the feedwater, are desirably removed by the submicron filtration process.

Referring again to Table 1, the initial turbidity of the feed water in Run 1 included concentrated organics and suspended solids corresponding to an initial turbidity of 182 TU and reduced by filtration to a lower concentration of organics and suspended solids corresponding to final turbidity of about 2.6. In addition, an initial turbidity of the feed water was greater than 1,000 TU for Run 3 corresponding to a relatively higher concentration of organics and suspended solids and reduced to a lower concentration of organics and suspended solids corresponding to a final turbidity of less than 1. In order to achieve the most rigorous operational condition for an exemplary system, the reject stream (unfiltered stream) organics and suspended solids were recycled back to the feed tank for recycling through the submicron filtration system.

TABLE 1

| | INITIAL | FINAL |
|---|---|---|
| FEED | TURBIDITY | TURBIDITY |
| STREAM | (TU) | (TU) |
| RUN 1 | 182 | 2.6 |
| RUN 2 | 192 | 1.0 |
| RUN 3 | >1000 | 0.99 |

As previously noted, in addition to the coagulant addition units e.g., 20A, 20B, other embodiments may include in the submicron filtration system, pH measuring and/or pH adjustment units e.g., 60A, 60B, and 60C, and/or one or more contaminant indicator units, e.g., 62A, 62B, 62C may further be included in the system.

In related embodiments, one or more controllers e.g. 90 may be configured to execute programmed instructions to cause one or more of the coagulant additive units to inject a predetermined amount respective coagulants.

In another embodiment, one or more controllers e.g. 90, may be configured to execute programmed instructions to receive a measurement of a pH and/or contaminant level at a selected point in the process stream of the submicron filtration process from one or more of the respective pH measuring/adjustment units and/or the contaminant indicator units, and in response make a determination of whether to cause the addition of and/or an amount of the coagulant additive to add to the process stream.

In a further embodiment, the one or more controllers may be configured to execute programmed instructions to receive a measurement of a pH and/or contaminant level at a selected point in the process stream of the submicron filtration process from one or more of the respective pH measuring/adjustment units and/or the contaminant indicator units, and in response make a determination of whether to cause the addition of and/or a determination of an amount of the coagulant additive to add to the process stream.

In another embodiment, the one or more controllers may be configured to execute programmed instructions to receive a measurement at a selected point in the process stream of the submicron filtration process of a pH level and/or contaminant level and in response make a determination of whether to cause the addition of and/or a determination of an amount of a pH adjusting additive to add.

In a further embodiment, the one or more controllers may be configured to execute programmed instructions to receive a measurement at a selected point in the process stream of the submicron filtration process of a pH level and/or contaminant level and in response make a determination of whether to alter process conditions of the submicron filtration process including adjusting a flow rate of the treatment stream through the one or more filtration units.

In another embodiment, the one or more controllers may be configured to execute programmed instructions to receive a measurement at a selected point in the process stream of the submicron filtration process of a pH level and/or contaminant level and in response select the type and/or number of filtration units to place in the treatment flow pathway and/or select the number and/or type of filters to place in the treatment flow pathway including the number of treatment passes through subunits and/or filters of a submicron filtration unit.

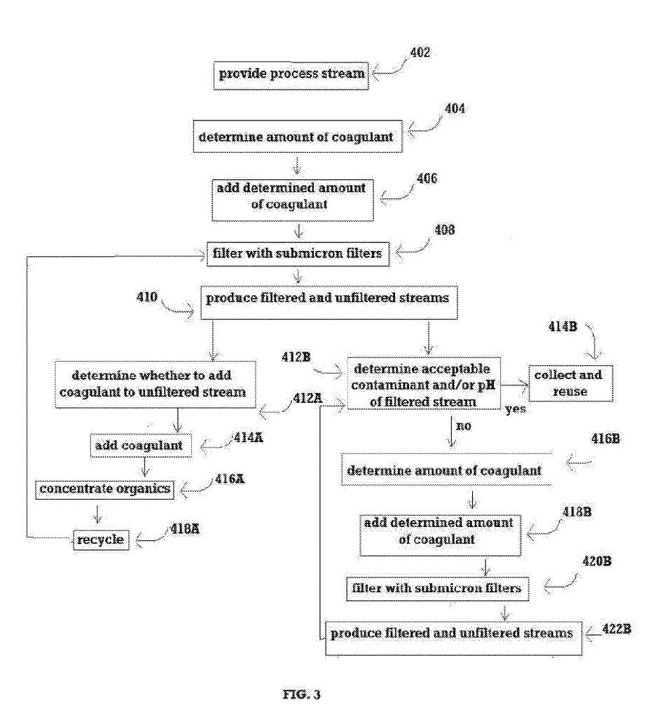

Referring next to FIG. 3, a flow diagram 400 of illustrative embodiments of a submicron filtration method carried out in embodiments of the filtration system is shown. The method may begin at block 402. At block 402, a process stream with organics and suspended solids may be provided. In block 404 a desired amount of coagulant to add to the process stream is determined. At block 406 the determined amount of coagulant is introduced into the process stream upstream of at least one submicron filtration unit. At block 408, the process stream is passed through the at least one submicron filtration unit. At block 410 the effluent from the submicron filtration unit produces a filtered process stream and an unfiltered process stream.

In block 412A a determination is made whether and/or an amount of coagulant to be added to the unfiltered process stream. In block 414A if it is determined to add any coagulant, a second determined amount of the same or another coagulant may be added. In block 416A organics and/or suspended solids in the unfiltered process stream may be further concentrated, i.e., by a sponge or a trap. In Block 418A a determination is made whether to recycle the unfiltered process stream for further filtration and if the determination is to recycle, the unfiltered process stream is recycled through the submicron filtering system, e.g., beginning at block 408.

In block 412B a determination is made whether a filtered process stream is at an acceptable pH and/or contaminant level. In block 414B, if the determination from block 412B is yes, the filtered process stream may be collected for reuse in an oil and gas process. In block 416B, if the determination from block 412B is that the pH and/or contaminant level is unacceptable, a further determination may be made whether to add and an amount of additional coagulant and/or other pH adjustment additive to add to the filtered process stream. In block 418B, the additional coagulant and/or pH adjustment additive may be added. In block 420B, the filtered process stream may be treated with another submicron filtration unit. In Block 422B, filtered and unfiltered streams are produced and collected and the filtered portion of the process stream may undergo further processing beginning at block 412B, and the unfiltered portion of the process stream may undergo further processing beginning with block 412A.

Although the embodiments of this disclosure have been described with respect to certain exemplary embodiments, it is to be understood that the specific embodiments are for purposes of illustration and not limitation, as other variations will occur to those of skill in the art.

What is claimed:

1. A filtration system for treating a water comprising suspended solids and organics comprising:
an input line carrying a process stream comprising suspended solids and organics;
at least one coagulant addition unit configured to add a predetermined amount of a first coagulant comprising at least one of cationic polymers and nonionic polymers to the process stream;
at least one submicron filtration unit comprising one or more submicron filters disposed downstream of the coagulant addition unit configured to receive the process stream;
a first process stream output line configured to receive an unfiltered portion of the process stream from the at least one submicron filtration unit; and,
a second process stream output line configured to receive a filtered portion of the process stream from the at least one submicron filtration unit.

2. The filtration system of claim 1, where the at least one coagulant addition unit comprises a second coagulant addition unit configured to add a predetermined amount of at least one of the first or another coagulant to the unfiltered portion of the process stream.

3. The filtration system of claim 1, further comprising a second submicron filtration unit downstream of the first submicron filtration unit.

4. The filtration system of claim 3, further comprising a third coagulant addition unit disposed between the first and second submicron filtration units, the third coagulant addition unit configured to add a predetermined amount of at least one of the first and another coagulant to the process stream.

5. The filtration system of claim 1, wherein the at least one submicron filtration unit comprises at least one filter configured to filter particle sizes of about 1 micron or less.

6. The filtration system of claim 1, wherein the at least one submicron filtration unit comprises at least one of a microfilter, ultrafilter, and nanofilter.

7. The filtration system of claim 1, further comprising a recycle line configured to return at least a portion of the unfiltered portion of the process stream to the at least one submicron filtration unit.

8. The filtration system of claim 1, further comprising an organic trap disposed downstream of the at least one submicron filtration unit, the organic trap configured to receive the unfiltered portion of the process stream to concentrate organics and suspended solids.

9. The filtration system of claim 1, further comprising one or more contaminant indicator units comprising a turbidimeter configured to indicate a numerical value corresponding to a level of contaminants in the process stream.

10. The filtration system of claim 9, wherein the one or more contaminant indicator units is in communication with the controller wherein the controller is configured to determine the predetermined amount of coagulant in response to communication with the one or more contaminant indicator units.

11. The filtration system of claim 9, further comprising a controller in communication with the at least one coagulant addition unit wherein the controller is configured to determine the predetermined amount of coagulant and the at least one coagulant addition unit is configured to add the predetermined amount of coagulant in response to receiving a command from the controller.

12. The filtration system of claim 9, further comprising one or more pH measuring/adjustment units configured to perform at least one of:
determine a pH of the process stream; and
supply a predetermined amount of pH adjusting additive to the process stream.

13. The filtration system of claim 12, wherein the one or more pH measuring units is in communication with the controller and wherein the controller is configured to determine in response to communication from the one or more pH measuring/adjustment units at least one of:
the predetermined amount of coagulant; and
the predetermined amount of pH adjusting additive.

14. A method for treating a water comprising suspended solids and organics comprising:
providing a process stream comprising suspended solids and organics;
adding a predetermined amount of at least one coagulant comprising at least one of a cationic polymer and nonionic polymer to the process stream to cause coagulation of contaminants comprising suspended solids and organics;
passing the process stream with the coagulant downstream to at least one submicron filtration unit comprising at least one filter configured to filter particle sizes of about 1 micron or less;
filtering the process stream with the at least one submicron filtration unit; and,
separating a filtered and unfiltered portion of the process stream from the at least one submicron filtration unit to pass downstream respectively in a filtered and an unfiltered process stream.

15. The method of claim 14, further comprising adding a predetermined amount of a second coagulant to the unfiltered process stream to concentrate contaminants comprising suspended solids and organics.

16. The method of claim 14, wherein passing the process stream with the coagulant downstream to at least one submicron filtration unit comprises passing the filtered process to a second submicron filtration unit downstream of the at least one submicron filtration unit.

17. The method of claim 16, further comprising adding a predetermined amount of at the least one coagulant to the filtered process stream prior to passing the filtered process stream to the second submicron filtration unit.

18. The method of claim 14, further comprising recycling at least a portion of the unfiltered process stream to the at least one submicron filtration unit for further filtration.

19. The method of claim 14, further comprising concentrating and separating the organics and suspended solids downstream of the at least one submicron filtration unit.

20. The method of claim 14, further comprising a controller processor executing programmed instructions stored in non-transitory memory, the controller:
determining the predetermined amount of at least one coagulant; and
communicating a command comprising the predetermined amount to at least one coagulant addition unit wherein the at least one coagulant addition unit is configured to add the predetermined amount to the process stream in response to receiving the command;
wherein determining the predetermined amount of at least one coagulant comprises receiving a communication from one or more contaminant indicator units comprising a turbidimeter, the communication comprising a determination by the one or more contaminant indicator units of a numerical value corresponding to a level of at least one of the suspended solids and organics in the process stream.
